(19) United States
(12) Patent Application Publication
(10) Pub. No.: US 2015/0114709 A1
(43) Pub. Date: Apr. 30, 2015

(54) SERVER CABINET

(71) Applicant: HONG FU JIN PRECISION INDUSTRY (ShenZhen)Co., Ltd., Shenzhen (CN)

(72) Inventors: HAN-YU LI, New Taipei (TW); CHENG-HE LI, Shenzhen (CN)

(73) Assignee: HON HAI PRECISION INDUSTRY CO., LTD., New Taipei (TW)

(21) Appl. No.: 14/078,531

(22) Filed: Nov. 13, 2013

(30) Foreign Application Priority Data
Oct. 29, 2013 (CN) 2013105170076

(51) Int. Cl. H02G 15/013

(52) U.S. Cl. CPC H02G 15/013
USPC 174/652

(57) ABSTRACT

A cabinet includes a board defining a through hole, a number of cables extending through the through hole, and a seal device. The seal device includes a limiting member mounted on the board, a sliding member slidably mounted to the board, and a fixing member. The limiting member defines a first receiving groove aligning with the through hole. The sliding member forms a sandwiching portion defining a second receiving groove. The sliding member is slid toward the first receiving groove of the limiting member. The first groove of the limiting member and the second groove of the sliding member sandwich the cables together to seal a gap between the cables and a sidewall bounding the through hole. The sliding member is fixed to the board by the fixing member.

### BACKGROUND

1. Technical Field

The present disclosure relates to a server cabinet.

2. Description of Related Art

Top boards or bottom boards of server cabinets often define through holes to allow cables to extend through. As a result, gaps are defined between sidewalls bounding the through holes and the cables, which allows cool air to escape out of the cabinets, thereby lowering a heat dissipation efficiency of the cabinets.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an assembled, isometric view of an embodiment of a server cabinet, wherein the server cabinet includes a board and a seal device.

FIG. 2 is an exploded, isometric view of the board and the seal device of FIG. 1.

FIG. 3 is an assembled, isometric view of FIG. 2.

FIG. 4 is similar to FIG. 3, but showing a state of use.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean “at least one.”

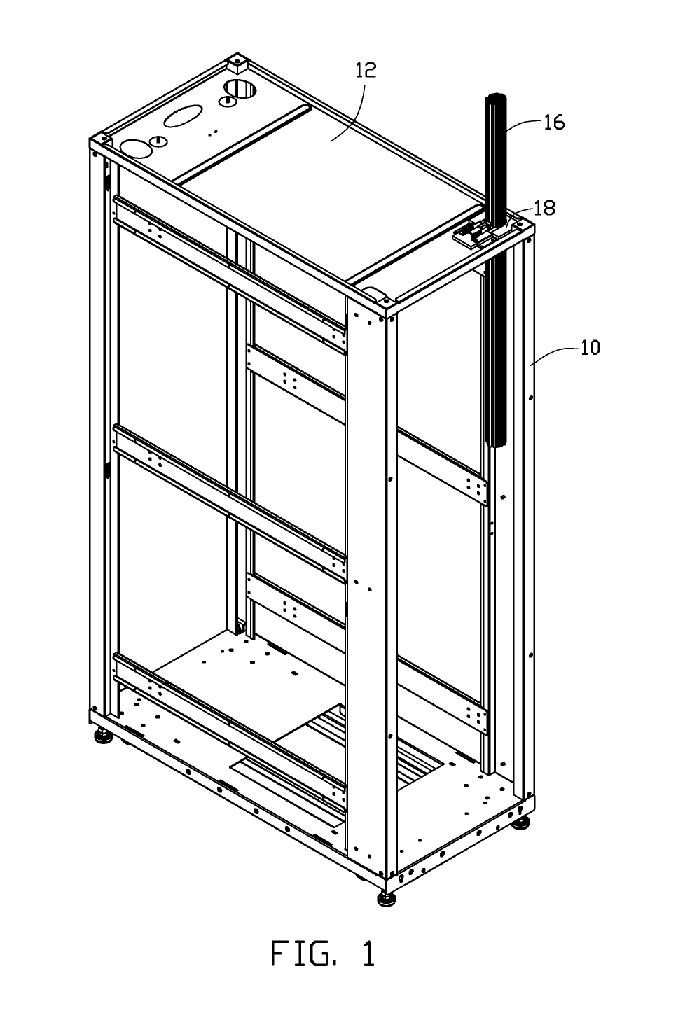

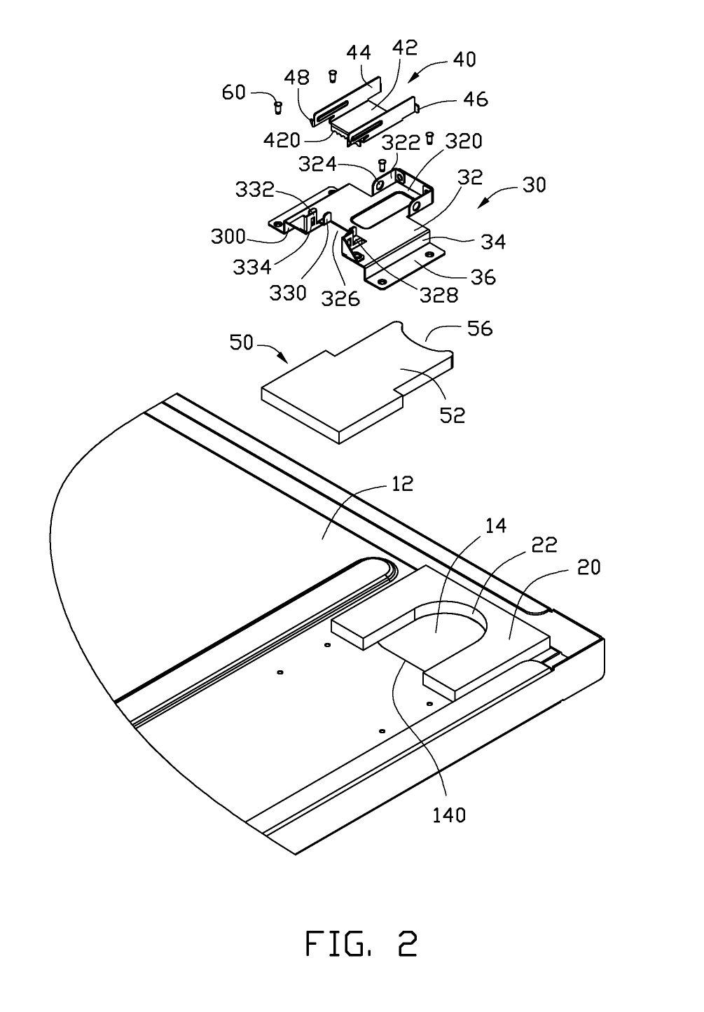

Referring to FIGS. 1 and 2, an embodiment of a server cabinet includes a board 12 defining a through hole 14, a plurality of cables 16 extending through the through hole 14, and a seal device 18 for sealing any space between the through hole 14 and the cables 16.

The seal device 18 includes a limiting member 20, an installing member 30, a fixing member 40, and a sliding member 50. In one embodiment, the limiting member 20 and the sliding member 50 are made of foam.

The limiting member 20 is mounted on the board 12. The limiting member 20 defines a substantially U-shaped first receiving groove 22 aligning with the through hole 14.

The installing member 30 includes a connecting piece 32, two side pieces 34 extending substantially perpendicularly down from opposite side edges of the connecting piece 32, respectively, and two fixing pieces 36 extending substantially perpendicularly from bottom edges of the two side pieces 34, respectively. A receiving space 300 is cooperatively bound by the connecting piece 32 and the side pieces 34. An extension piece 320 extends rearward from a rear end of the connecting piece 32. Two arms 322 extend substantially perpendicularly up from opposite side edges of the extension piece 320, respectively. Each arm 322 defines a pivot hole 324. A cutout 326 is defined in a front end of the connecting piece 32. Two supporting pieces 328 extend toward each other from opposite sides of the cutout 326. A blocking piece 330 extends up from a distal end of each supporting piece 328. Two latching pieces 332 adjacent to the blocking pieces 330 extend up from opposite sides of the cutout 326. The latching pieces 332 are in front of the blocking pieces 330, and each latching piece 332 defines a latching hole 334.

The fixing member 40 includes two hooking pieces 44 and a connecting portion 42 connected between bottom sides of the hooking pieces 44. Two pins 46 extend away from each other from rear ends of the hooking pieces 44. Two projections 48 extend away from each other from front ends of the hooking pieces 44. A plurality of protrusions 420 protrudes from a front end of a bottom surface of the connecting portion 42. The pins 46 are pivotably received by the pivot holes 324 to pivotably mount the fixing member 40 to the installing member 30.

A rear end of the sliding member 50 forms a sandwiching portion 52. The sandwiching portion 52 defines an arc-shaped second receiving groove 56. A width of the sandwiching portion 52 is substantially equal to a width of the first receiving groove 22.

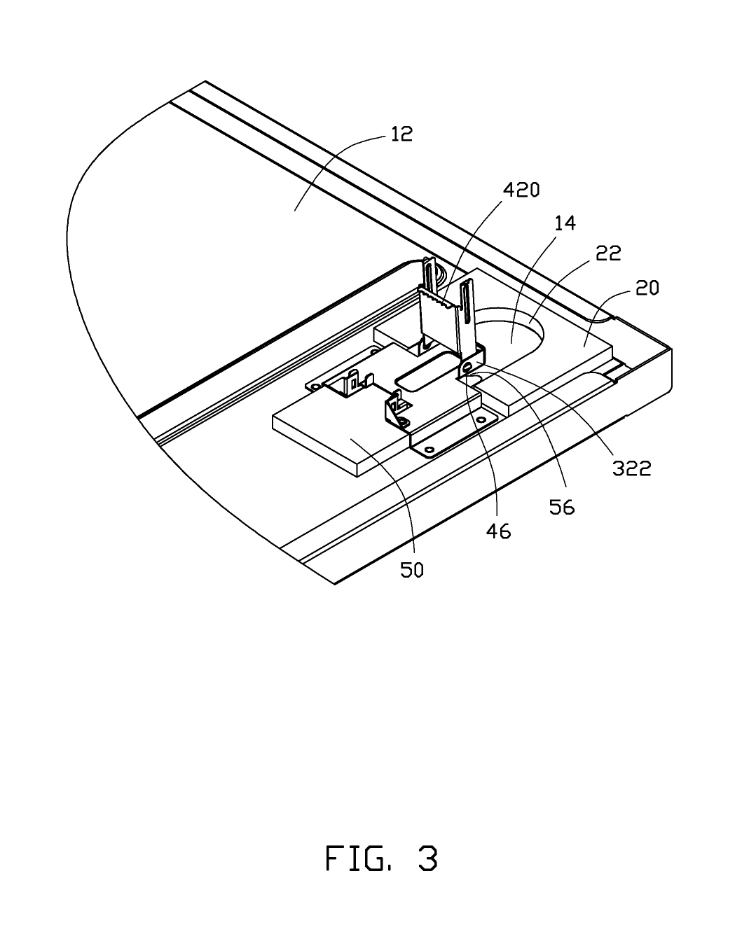

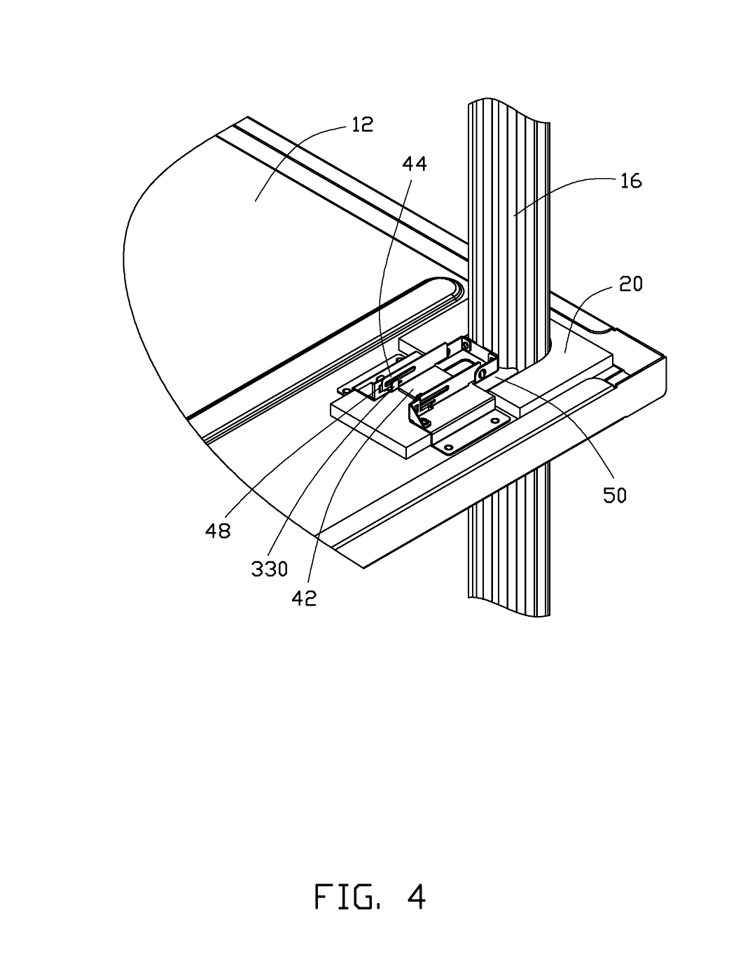

Referring to FIGS. 3 and 4, in assembly, the limiting member 20 is mounted on the board 12, such that the first receiving groove 22 aligns with the through hole 14. The fixing pieces 36 of the installing member 30 are mounted to the board 12 by screws 60, such that the extension piece 320 protrudes toward the first receiving groove 22. The sliding member 50 is slidably received in the receiving space 300 of the installing member 30, such that the second receiving groove 56 and the first receiving groove 22 face each other.

In use, the cables 16 are received through the through hole 14 and the first receiving groove 22. The sliding member 50 is then slid toward the limiting member 20 to allow the sandwiching portion 52 to enter the first receiving hole 22, until inner walls bounding the first receiving groove 22 and the second receiving groove 56 clamp the cables 16 firmly. The cables 16 are received in a part of the first receiving hole 22 uncovered by the sandwiching portion 52 and the second receiving hole 56. Therefore, the limiting member 20 and the sliding member 50 sandwich the cables 16 and cover a gap between sidewalls bounding the through hole 14 and the cables 16, to prevent cool air from escaping through the gap.

The fixing member 40 is then pivoted forward until the hooking pieces 44 contact the supporting pieces 328, and the projections 48 are detachably received in the latching holes 334. The blocking pieces 330 block the hooking pieces 44 from bending toward each other. At this time, the protrusions 420 tightly contact the sliding member 50 to frictionally prevent the sliding member 50 from sliding.

To accommodate less or more cables 16, the hooking pieces 44 are deformed toward each other to disengage the projections 48 from the corresponding latching holes 334. The fixing member 40 is then pivoted away from the sliding member 50 to allow the sliding member 50 to slide to a suitable position. The fixing member 40 is then pivoted toward the sliding member 50 again to be fixed to the installing member 30.

In another embodiment, the extension piece 320 can be omitted, such that the arms 322 extend up from the connecting piece 32.

In another embodiment, the supporting pieces 328 and the blocking pieces 330 can be omitted.

In another embodiment, the sliding member 50 can be fixed to the board 12 by other means, such as by screws or adhesive tape.

It is believed that the present embodiments and their advantages will be understood from the foregoing description, and various changes may be made thereto without departing from the spirit and scope of the description or sacrificing all of their material advantages, the examples hereinbefore described merely being exemplary embodiments.

What is claimed is:

1. A cabinet, comprising:
a board defining a through hole;
a plurality of cables extending through the through hole; and
a seal device comprising a limiting member mounted on the board and defining a first receiving groove aligning with the through hole, a sliding member slidably mounted on the board and forming a sandwiching portion, and a fixing member, the sandwiching portion defining a second receiving groove;
wherein the sliding member is operable to slide toward the limiting member, to allow the sandwiching portion to enter the first receiving groove; the limiting member and the sliding member sandwich the cables together and seal a gap between the plurality of cables and a sidewall bounding the through hole; the plurality of cables is received in a part of the first receiving groove uncovered by the sandwiching portion and the second receiving groove, the fixing member is then to fix the sliding member to the board.

2. The cabinet of claim 1, wherein the limiting member and the sliding member are made of foam.

3. The cabinet of claim 1, wherein the seal device further comprises an installing member mounted to the board, a rear end of the fixing member is pivotably mounted to the installing member, a front end of the fixing member opposite to the rear end is detachably latched with the installing member.

4. The cabinet of claim 3, wherein a bottom surface of the fixing member forms a plurality of protrusions to press the sliding member.

5. The cabinet of claim 3, wherein the installing member defines two pivot holes in a rear end and two latching holes in a front end opposite to the rear end, two pins extend from the rear end of the fixing member and are pivotably inserted into the pivot holes, two projections extend from the front end of the fixing member and are detachably engaged in the latching holes.

6. The cabinet of claim 5, wherein the fixing member comprises two hooking pieces and a connecting portion connected between the hooking pieces, the projections extend out from the hooking pieces, two supporting pieces extend toward each other from the front end of the installing member to support the hooking pieces when the projections are engaged in the latching holes.

7. The cabinet of claim 6, wherein a blocking piece extends up from a distal end of each supporting piece to block a corresponding one of the hooking pieces.

8. The cabinet of claim 6, wherein a bottom surface of the connecting portion forms a plurality of protrusions to press the sliding member.

9. The cabinet of claim 3, wherein the installing member comprises a connecting piece, two side pieces extending down from opposite sides of the connecting piece, and two fixing pieces extending out from bottom sides of the side pieces to be fixed to the board, a receiving space is bounded by the connecting piece and the side pieces, the fixing member is slidably received in the receiving space and contacts the board.
